(19) United States
(12) Patent Application Publication
(10) Pub. No.: US 2003/0135666 A1
(43) Pub. Date: Jul. 17, 2003

(54) METHOD FOR DISPLAYING OPERATION STATE OF SYSTEM DEVICES IN NETWORK SYSTEM

(76) Inventor: DO-HYOUNG KIM, KYUNGKI-DO (KR)

Correspondence Address: SUGHRUE MION ZINN MACPEAK & SEAS, 2100 PENNSYLVANIA AVENUE NW, WASHINGTON, DC, 20037-3202, US

(21) Appl. No.: 09/445,769

(22) PCT Filed: May 3, 1999
(86) PCT No.: PCT/KR99/00215

(30) Foreign Application Priority Data
May 6, 1998 (KP) 98-16141

(51) Int. Cl. G06F 3/00

(52) U.S. Cl. 710/1

(57) ABSTRACT

A method for displaying changes in the operation states of devices in an IEEE 1394 network system is provided. The method for displaying changes in the operation states of network devices on a display screen of a device which operates as a client in an IEEE 1394 network when various digital devices connected to the network operate as the client or the servers, having the same protocol layer as an Internet protocol stack on the upper network communication layer, includes the steps of (a) the device which operates as the client (the client device) establishing a communication channel with respect to devices which operate as the servers (server devices), (b) the server devices transmitting a predetermined signal for indicating changes in the operation states thereof to the client device when the server devices perform a predetermined operation and stops the operation or performs another operation, and (c) the client device receiving the predetermined signal from the server devices and displaying the change in the operation state of a concerned server device on a screen thereof. According to the present invention, the user can see changes in the operations states of the devices connected to the IEEE 1394 network on the screen of one device among the devices and can effectively control the operation of a desired device.

### TECHNICAL FIELD

The present invention relates to a network, and more particularly, to a method for displaying a network system operation state so that a user can see changes in the operations of devices connected to the network through a device among the devices in real time.

### BACKGROUND ART

FIG. 1 shows a protocol stack of a network device. A general protocol stack in which respective devices adopting a network communication function is comprised of a physical layer 100 which is the lowest layer 100, a link layer 110, a transaction layer 120, and a serial bus management layer 130 which is the upper most layer. The physical layer 100 receives a bit column from the link layer 110 during transmission, obtains the right to use a serial bus, encodes the bit column, converts the bit column into an electrical signal, and transfers the signal to an external bus. Reverse processes are performed during reception. The link layer 110 deals with data in units of a packet and has functions of constructing and dismantling a packet, detecting errors, and managing a bus cycle. In general, the physical layer 100 and the link layer 110 are comprised of a chipset. The transaction layer 120 provides a transaction such as reading/writing/locking of data and performs asynchronous communication with different devices (or nodes) on the network bus using the service provided by the lowest layer. A serial bus management layer 130 holds various material structures such as a configuration ROM and a control and status register (CSR) and manages the connection structure of an entire system connected to a power supply and a bus (topology)/speed map. The transaction layer 120 and the serial bus management layer 130 are formed of software and is realized by being built into the microcomputer of the respective devices.

FIG. 2 shows a block diagram of a digital device having the network communication function. The digital device is comprised of a device dependent hardware 200, a microcomputer 210, a physical layer execution block 220, and a link layer execution block 230. The device dependent hardware 200 executes a characteristic function of a concerned device. The microcomputer 210 for supporting the network communication executes the operation including the transaction layer and the serial bus management layer, described in FIG. 1. The physical layer execution block 220 is hardware for realizing the function of the physical layer 100 of FIG. 1. The link layer execution block 230 is hardware for realizing the CIP header inserting/removing functions of the link layer 110 and IEC 61883.

In a conventional technology, various digital devices are connected to each other on the network as mentioned above and transmit and receive data. However, a user cannot see the operations of all devices at one sight.

### DISCLOSURE OF THE INVENTION

To solve the above problem, it is an object of the present invention to provide a method for displaying the operations of devices over a network by which a user can see the operations of the devices on the network on a screen of one device and control the devices.

Accordingly, to achieve the above objective, there is provided a method for displaying changes in the operation states of network devices on a display screen of a device which operates as a client in an IEEE 1394 network when various digital devices connected to the network operate as the client or the servers, having the same protocol layer as an Internet protocol stack on the upper network communication layer, comprising the steps of (a) the device which operates as the client (the client device) establishing a communication channel with respect to devices which operate as the servers (server devices), (b) the server devices transmitting a predetermined signal for indicating changes in the operation states thereof to the client device when the server devices perform a predetermined operation and stops the operation or performs another operation, and (c) the client device receiving the predetermined signal from the server devices and displaying the change in the operation state of a concerned server device on a screen thereof.

The client device preferably establishes a communication channel with respect to the server devices by periodical polling in the step (a).

A Java applet preferably operates through the communication channel when the client device established the communication channel with respect to the server devices in step (a).

The network is preferably an IEEE 1394 network.

To achieve the above objective, there is provided a method for displaying changes in the operation states of network devices on a display screen of a device which operates as a client in a network when various digital devices connected to the network operate as the client or the servers, having the same protocol layer as an Internet protocol stack on the upper network communication layer (physical layer), comprising the steps of the client device receiving data on the operation states of the server devices connected to the network bus, in a network communication layer, the client device examining whether the previous operation state data of the server devices is different from the current operation state data, in a network communication layer, the client device transmitting the current operation state of a server device, whose previous operation state data is different from the current operation state data from the 1394 communication layer, to a hypertext transmission protocol (HTTP) layer which is the upper most protocol layer of the client device, and the client device displaying the change of the operation state of the concerned server device on a screen thereof according to the contents transmitted to the HTTP layer.

### BRIEF DESCRIPTION OF THE DRAWINGS

The above objective and advantages of the present invention will become more apparent by describing in detail a preferred embodiment thereof with reference to the attached drawings in which:

FIG. 1 shows a protocol stack of a network device;

FIG. 2 shows a block diagram of a digital device having a network communication function;

FIG. 3 is an example of the structure of the network for describing the present invention;

FIG. 4 shows the network protocol stack of FIG. 3;

FIG. 5 is a flowchart of a method for displaying changes in the operation states of network devices according to the present invention;

FIG. 6 is a flowchart of another method for displaying changes in the operation states of network devices according to the present invention; and

FIG. 7 shows the contents of FIG. 6 using a protocol layer diagram of a digital TV.

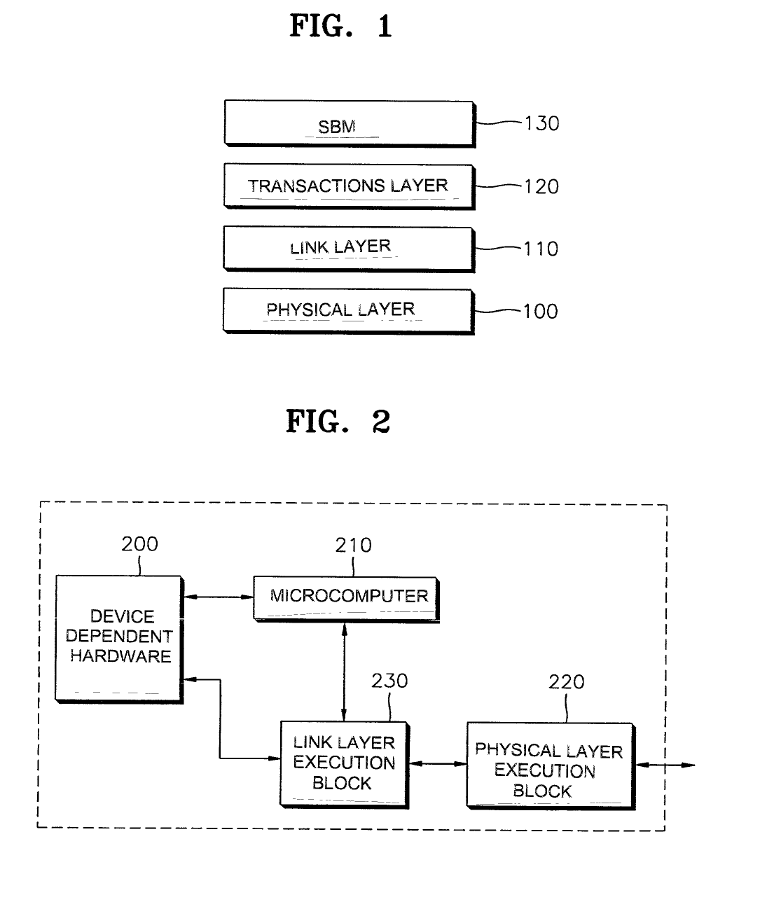

### BEST MODE FOR CARRYING OUT THE INVENTION

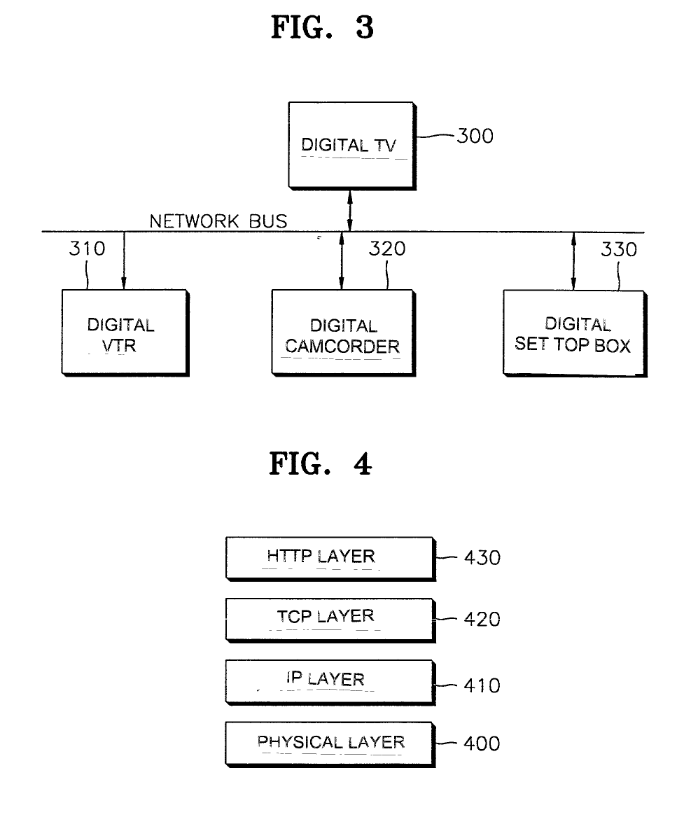

FIG. 3 is an example of the structure of a network for describing the present invention. A digital TV 300, a digital VCR 310, a digital camcorder 320, and a digital set top box 330 are connected to a network. The respective digital devices 300 through 330 transmit and receive data according to a client/server method used in a general intranet/Internet, including a protocol layer as shown in FIG. 4. Here, the digital TV 300 by which a user can see predetermined images and character data on a screen operates as a client and includes a web browser. The digital devices 310 through 330 play the same role as that of a web server on the Internet. The hypertext documents to be transferred by the respective devices is in a HTML document hierarchy including information on the functions and the operations of the respective devices. The digital TV 300 which is the client accesses the respective web sites from the web server devices 310 through 330 using the web browser and controls concerned devices. Namely, a user can control the characteristic operations such as reproducing and recording operations of the remaining devices, i.e., the DTV 300 through the DVCR 310.

FIG. 4 shows the network protocol layer of FIG. 3, which is comprised of a physical layer 400, an IP layer 410, a transmission control protocol (TCP) layer 420, and hypertext transmission protocol (HTTP) layer 430. The physical layer 400 is for transmitting and receiving data through a 1394 network bus. In the IP layer 410, a protocol for independently connecting independently managed communication networks to each other is adopted in order to use the communication networks together. In the TCP layer 420, a communication net protocol of a system connected through the Internet is adopted. In the HTTP layer 430, a communication protocol used for exchanging the hypertext document in the Internet is adopted.

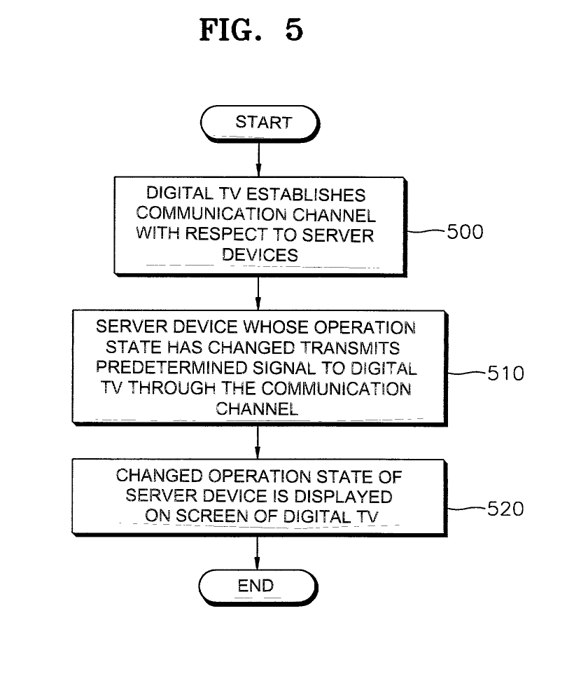

FIG. 5 is a flowchart of a method for displaying changes in the operation states of network devices of the present invention, in which changes in the operation states of server devices in the system as shown in FIG. 3, connected to the network, to which the protocol stack as shown in FIG. 4 is applied, are displayed. First, the digital TV 300 establishes a communication channel with respect to the digital VCR 310, the digital camcorder 320, and the digital set top box 330, which are server devices (step 500). The communication channel can be established by a method of maintaining a channel connection once a channel is opened and a polling method in which the digital TV 300 repeats processes of opening a channel, communicating with a server device, and terminating a communication connection by closing the channel, with respect to the server devices 310 through 330. Also, when the digital TV 300 establishes a channel with respect to the server device, it is possible to easily transmit a predetermined signal with respect to the change in the operation state of the server device from the server device to the digital TV 300 by operating a Java applet which establishes a communication between the client and the server performed on the network. When the channel established server device performs a predetermined operation and stops the operation or performs another operation, a predetermined signal indicating a change in the operation is transmitted to the digital TV 300 through the established channel (step 510). The digital TV 300 receives the predetermined signal indicating the change in the operation and displays the change in the operation of a concerned server device or contents of the change on a screen (step 520).

FIG. 6 is a flowchart of another method for displaying changes in the operation states of network devices according to the present invention, in which changes in the operations states of server devices in the system as shown in FIG. 3, connected to a network, to which the protocol stack as shown in FIG. 4 is applied, are displayed. First, the digital TV 300 takes data on the operations of the server devices 310 through 330 transmitted to the network bus in the physical layer (step 600). The digital TV 300 memorizes previous operation states of the server devices, receives the current operation states of the server devices, compares the received current operation states with the previous operation states, and examines whether they are different from each other (step 610). The physical layer of the digital TV 300 transmits the current operation state of a server device, whose previous operation state data is different from the current operation state data from the 1394 layer, to the hypertext transmission protocol HTTP layer which is the upper most protocol layer (step 620). The digital TV 300 displays the contents of the change in a server device whose operation state is changed, which are transmitted to the HTTP layer, on a screen (step 630).

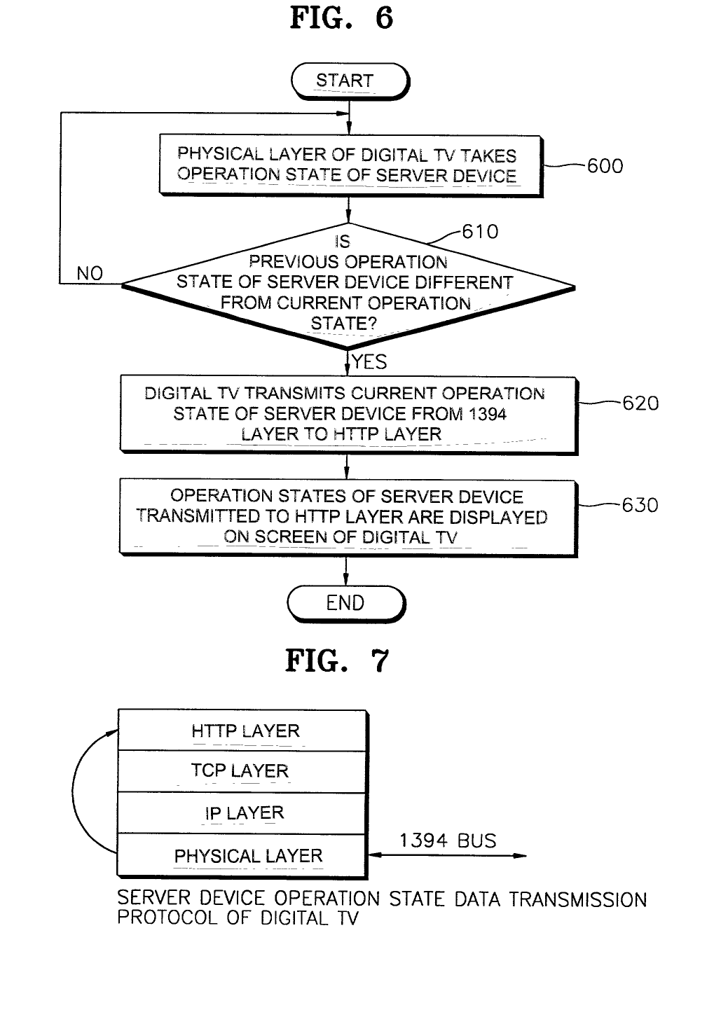

FIG. 7 shows the contents of FIG. 6 using the protocol layer diagram of the digital TV. It is noted from FIG. 7 that the operation state data of the server device received on the network bus can be directly transmitted to the HTTP layer, skipping over the remaining layers.

The network mentioned here is a network such as an IEEE 1394 network in which communication can be performed between devices connected to the network by a client/server method.

The above-mentioned embodiment of the present invention can be embodied in a program which can be executed in a computer. The embodiment can be realized in a generally used digital computer for operating the program from a medium used in the computer. The medium can be a storage medium such as a magnetic storage medium (CD-ROM and DVD) or a carrier wave (transferred through the Internet).

The recording medium stores a program code which can execute a first step in which a client device establishes a communication channel with respect to a server device, a second step in which a predetermined signal is transmitted from the server device to the client device when the server device performs a predetermined operation and stops the operation or performs another operation, and a third step in which the client device receives a predetermined signal from the server device and displays the change in the operation state of a concerned server device on the screen thereof, in the network system having the protocol stack of FIG. 4. The program is positioned in an upper layer as it prevents more errors of the video data. The upper layer and the lower layer have backward compatibility in which the upper layer includes the lower layer. The program is coded so that more errors are prevented with respect to data which considerably affects picture quality.

A functional program, a code, and a code segment for realizing the present invention can be easily realized by programmers knowledgeable in the art.

### INDUSTRIAL APPLICABILITY

According to the present invention, the user can see changes in the operations states of the devices connected to a network on the screen of one device among the devices and can effectively control the operation of a desired device.

What is claimed is:

1. A method for displaying changes in the operation states of network devices on a display screen of a device which operates as a client in an network when various digital devices connected to the network operate as the client or the servers, having the same protocol layer as an Internet protocol stack on the upper network communication layer, comprising the steps of:
(a) the device which operates as the client (the client device) establishing a communication channel with respect to devices which operate as the servers (server devices);
(b) the server devices transmitting a predetermined signal for indicating changes in the operation states thereof to the client device when the server devices perform a predetermined operation and stops the operation or performs another operation; and
(c) the client device receiving the predetermined signal from the server devices and displaying the change in the operation state of a concerned server device on a screen thereof.

2. The method of claim 1, wherein the client device establishes a communication channel with respect to the server devices by periodical polling in the step (a).

3. The method of claim 1, wherein a Java applet operates through the communication channel when the client device established the communication channel with respect to the server devices.

4. The method of claim 1, wherein the network is an IEEE 1394 network.

5. A method for displaying changes in the operation states of network devices on a display screen of a device which operates as a client in a network when various digital devices connected to the network operate as the client or the servers, having the same protocol layer as an Internet protocol stack on the upper network communication layer (physical layer), comprising the steps of:
the client device receiving data on the operation states of the server devices connected to the network bus, in a network communication layer;
the client device examining whether the previous operation state data of the server devices is different from the current operation state data, in a network communication layer;
the client device transmitting the current operation state of a server device, whose previous operation state data is different from the current operation state data from the 1394 communication layer, to a hypertext transmission protocol (HTTP) layer which is the upper most protocol layer of the client device; and
the client device displaying the change of the operation state of the concerned server device on a screen thereof according to the contents transmitted to the HTTP layer.
